(19) United States
(12) Patent Application Publication
(10) Pub. No.: US 2014/0183003 A1
(43) Pub. Date: Jul. 3, 2014

(54) Cold Planer with Aligned Transition Zone

(71) Applicant: CATERPILLAR INC., Peoria, IL (US)

(72) Inventors: John E. Jorgensen, Andover, MN (US); Michael Stevens, St. Paul, MN (US)

(73) Assignee: Caterpillar Inc., Peoria, IL (US)

(21) Appl. No.: 13/731,579

(22) Filed: Dec. 31, 2012

(51) Int. Cl. B65G 37/00

(52) U.S. Cl. CPC B65G 37/00
USPC 198/602

(57) ABSTRACT

A machine is provided. The machine includes a first conveyor and a second conveyor that is pivotable, with respect to the first conveyor, about two different axes that intersect and define a plane. A machine capable of performing a method for operating a set of conveyors is also provided. The method includes pivoting a second conveyor with respect to a first conveyor about two different axes that intersect and define a plane.

### TECHNICAL FIELD

The disclosure relates generally to a machine and, more particularly, to a machine with at least one articulating conveyor.

### BACKGROUND

Many machines are mobile machines configured to perform one or more tasks while traveling along a ground surface, such as a road surface. A cold planer is an example of such a mobile machine. The cold planer includes a grinding mechanism that grinds a top layer of the road surface. The cold planer includes a conveyor, connected to a frame of the machine, which receives the material that was removed from the road surface. The conveyor conveys the material to another vehicle, such as a dump truck, traveling next to the cold planer. The conveyor may be rotated relative to the machine frame, such that the conveyor is positioned to deposit the material into the dump truck, for example.

In some instances it may be desirable to allow a conveyor to pivot in order to adjust the position of the conveyor. One of the problems associated with moving or pivoting a conveyor is the prospect of material falling off of the conveyor or otherwise losing material through gaps between the conveyor and structure with respect to which the conveyor has been pivoted. US patent publication number 2006/0061204 describes a conveyor that can be pivoted using a four bar mechanism. However, the conveyor in this publication swings to the right or left but does not pivot to adjust the elevation of the conveyor.

### SUMMARY

In one embodiment, a machine is provided. The machine includes a first conveyor and a second conveyor that is pivotable, with respect to the first conveyor, about two different axes that intersect and define a plane.

In another embodiment, machine capable of performing a method for operating a set of conveyors is provided. The method includes pivoting a second conveyor with respect to a first conveyor about two different axes that intersect and define a plane.

### BRIEF DESCRIPTION OF THE DRAWINGS

FIG. 1 is a side view pictorial illustration of a machine having an exemplary disclosed pivotal connection between a frame and a conveyor.

FIG. 2 illustrates a side view of an exemplary machine having a pivotal conveyor, according to one embodiment of the present disclosure.

FIG. 3 is an isometric view of two conveyors with a transition zone therebetween.

FIG. 4 is a side view of the transition zone.

FIG. 5 is an isometric view of the transition zone with the flashing removed.

### DETAILED DESCRIPTION

The disclosure will now be described with reference to the drawing figures, in which like reference numerals refer to like parts throughout. An embodiment in accordance with the present disclosure provides a machine, such as, a cold planer that has two conveyors that are pivotal with respect to each other about at least 2 different pivot axes.

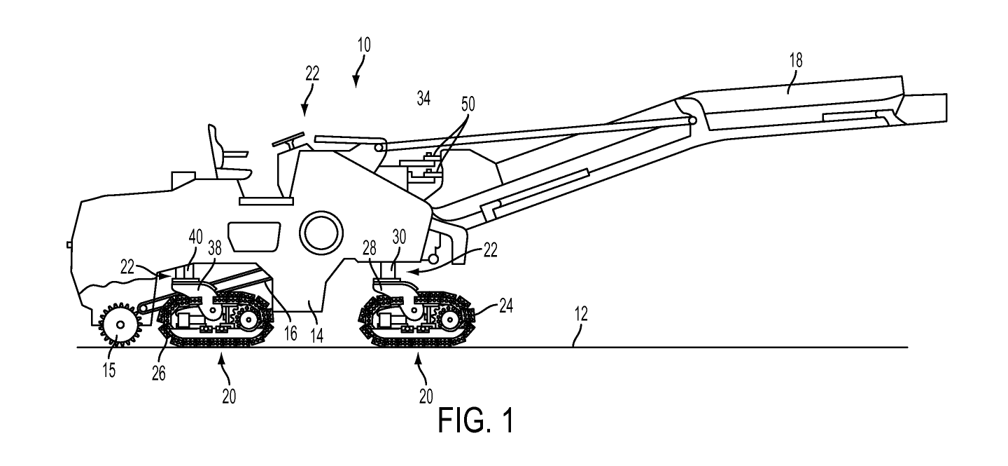

FIG. 1 illustrates an embodiment of a machine 10 in accordance with the present disclosure. Machine 10 is a mobile machine operable to move along a ground surface 12. The ground surface 12 may be a man-made surface, such as a road, parking lot, concrete cement, or other paved surface.

The machine 10 is configured to perform various functions when traveling over the ground surface 12. In the embodiment shown in FIG. 1, the machine 10 is a cold planer. In such an embodiment, the machine 10 is configured to cut or grind a top layer of concrete, asphalt, or similar material, to a depth that is typically between 1″ to 14″ below the ground surface 12.

The machine 10 includes a frame 14. The frame 14 serves to tie together and support other components and systems of the machine 10. In addition to the frame 14, the machine 10 has various other components and systems that serve various purposes. In the embodiment where the machine 10 is a cold planer, a frame 14 supports a material removal mechanism such as a cutting drum 15 that is configured to cut or grind the top layer of ground surface 12. In the embodiment shown in FIG. 1, the cutting drum 15 is a grinding mechanism that includes a rotor with a plurality of teeth configured to grind the ground surface 12. However, the cutting drum 15 is not limited to such an arrangement. Although FIG. 1 shows a cutting drum 15 housed in a rear , lower portion of the machine 10, the cutting drum 15 may be disposed in various places on the machine 10. Alternatively or additionally, the machine 10 may include one or more supplementary grinding mechanisms that are located in rear and/or forward positions in the machine 10.

The frame 14 supports a lower conveyor 16 that is located adjacent the cutting drum 15 and configured to receive the material removed from the ground surface 12 by the cutting drum 15. The frame 14 also supports an upper conveyor 18 configured to receive the material from the lower conveyor 16 and to further convey the material to a location off of the machine 10, such as to a receiver (e.g., another truck separate from machine 10). For example, the truck may be a dump truck that includes a bed. The dump truck may drive next to the machine 10 during grinding of the ground surface 12, at approximately the same speed as the machine 10, so that the material is conveyed by the upper conveyor 18 and dropped into the bed.

The machine 10 may also include one or more power sources (not shown) for powering the cutting drum 15, the upper conveyor 18, and/or various other components and systems of machine 10. For example, the machine 10 may include one or more internal combustion engines, batteries, fuel cells, or the like for providing power. The machine 10 may also include various provisions for transmitting power from such power sources to the cutting drum 15 and/or various other components of the machine 10. For example, where the machine 10 includes an internal combustion engine as a power source, the machine 10 may include one or more mechanical or electrical power-transmission devices, such as, mechanical transmissions, hydraulic pumps and motors, and/or electric generators and motors, for transmitting power from the engine to the cutting drum 15 and upper conveyor 18.

The machine 10 includes a support system 20 and a steering system 22 to support the machine 10 from the ground surface 12 and steer the machine 10 while moving along the ground surface 12. The support system 20 includes one or more front ground-engaging components 24 and one or more rear ground-engaging components 26 configured to move along ground surface 12. The ground-engaging components 24,26 are connected to struts 30, 40 via under carriage brackets 28, 38. FIG. 1 shows a front ground-engaging component 24 on a right side of machine 10, as well as a rear ground-engaging component 26 on the right side of machine 10. The machine 10 includes similar front and rear ground-engaging components 24, 26 on a left side. Each ground-engaging component 24, 26 includes any device or devices configured to move across ground surface 12, including but not limited to track units, wheels, and skids.

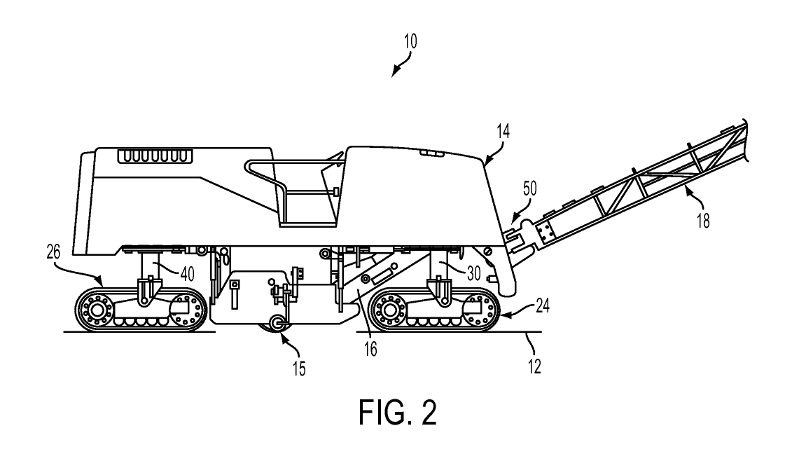

Another example machine is shown in FIG. 2. An exemplary machine 10 in which disclosed embodiments may be implemented is schematically illustrated in FIG. 2. In the accompanied drawings, the machine 10 is illustrated as a cold planer machine. The machine 10 may be used in the art of construction.

The machine 10 includes a plurality of ground-engaging components or drive tracks 24,26 configured for propelling the machine 10 along a ground surface 12. The machine 10 also includes a cutting drum 15, supported on the frame 14. The cutting drum 15 mills the road surface. A cutting plane of the machine 10 may be tangent to the bottom of the cutting drum 15 and parallel to the direction of travel of the machine 10. The drive tracks 24, 26 of the machine 10 are connected to a frame 14 of the machine 10 by hydraulic legs or struts 30, 40. The hydraulic legs or struts 30, 40 are configured to raise and lower the cutting drum 15 relative to the drive tracks 24, 26 so as to control a depth of cut for the cutting drum 15.

The machine 10 is further equipped with a lower 16 and upper conveyor 18 configured to transport excavated asphalt from the cutting drum 15 to a discharge location such as the bed of a dump truck.

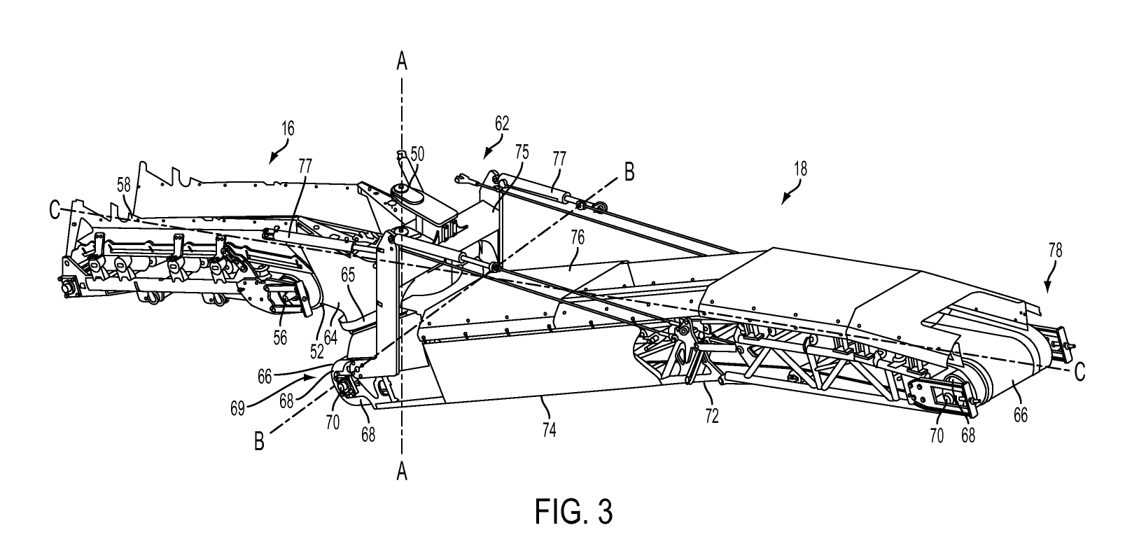

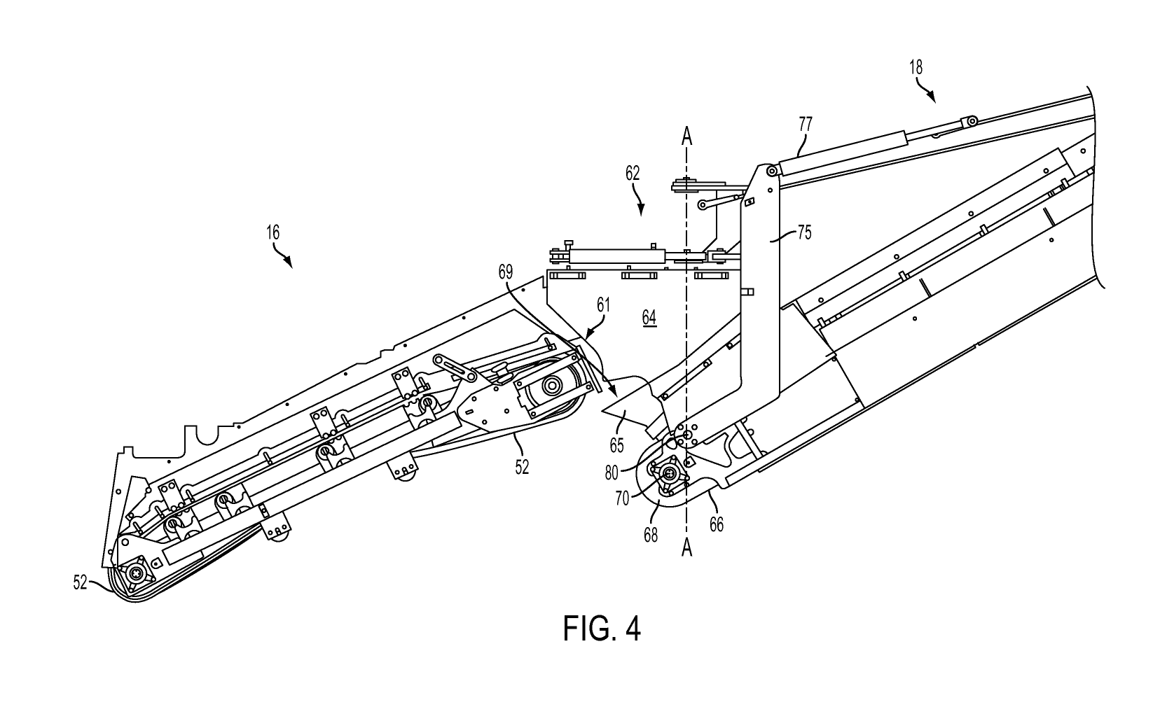

FIG. 3 is an isometric view of the lower conveyor 16 and the upper conveyor 18. FIG. 4 is a partial side view of the lower conveyor 16 and the upper conveyor 18. As shown in both FIGS. 3 and 4,

The lower conveyor 16 is attached to the frame 14 and an anti-slab structure through a linkage and sliding mechanism (not shown). The upper conveyor 18 is attached to the frame 14 through a pivotal structure 50. The mechanism of the lower conveyor connection controls the discharge location of the lower conveyor 16 through the various working depths of the machine 10. The lower conveyor 16 includes a discharge end 61. The discharge end 61 of the lower conveyor 16 is located at the transition zone 62. The transition zone 62 is the area between the lower conveyor 16 and the upper conveyor 18. Generally, material passing from the discharge end 61 of the lower conveyor 16 to intake end 69 the upper conveyor 18 does so at the transition zone 62.

In some embodiments of the disclosure, the transition zone 62 has flashing 64. The flashing 64 aides in guiding material moving from the lower conveyor 16 to the upper conveyor 18 and helps reduce the likelihood of material falling off the conveyors 16, 18. An intake hopper 65 acts as a transition guide on the upper conveyor 18. The intake hopper 65 is often a steel component. The intake hopper 65 is, as shown in FIGS. 3-5 be primarily mounted to the upper conveyor 18. Other portions of the flashing 64 may be attached to the lower conveyor 16.

The upper conveyor 18 includes an upper conveyor belt 66 that rides on the upper head pulleys 68. The upper head pulleys 68 ride on upper head pulley axles 70 which are attached to the upper conveyor frame 72. In some embodiments of the disclosure and as shown in FIG. 3, the upper conveyor 18 has an upper conveyor frame housing 74 which provides a housing for the upper conveyor frame 72. Some of the upper conveyor frame housing 74 is not shown in FIG. 3 in order to better illustrate the upper conveyor frame 72. It will be understood by those of ordinary skill in the art that some embodiments can include upper conveyor frame housing 74 and other embodiments may not. The upper conveyor frame 72 is mounted to the frame 14 through an upper frame superstructure 75 which is equipped with actuators 77 and other devices in order to allow the upper conveyor 18 to pivot about the axis B-B shown in FIG. 3.

The operation and structure of conveyors generally is well known as well as the ability of the conveyors to pivot whether vertically (about axis B-B) or pivot along the slew axis (A-A). In addition to the specific structure shown in the FIGS. one of ordinary skill in the art after reading this disclosure will appreciate that other types of conveyors and mechanisms for pivoting the upper conveyor 18 with respect to the lower conveyor 16 may be used and fall within the scope of this disclosure.

FIG. 3 illustrates the discharge end 78 of the upper conveyor 18. In many embodiments, the discharge end 78 of the upper conveyor 18 is oriented proximate to a dump truck in order for material moving along the upper conveyor 18 to be deposited into the dump truck. FIG. 3 also illustrates that material moving along the lower conveyor 16 across the transition zone 62 and along the upper conveyor 18 moves in the same general direction of travel as illustrated by dashed line C-C. In other embodiments in accordance with the disclosure, the upper conveyor 18 may be rotated on the pivotal connection 50 about axis A-A so the lower conveyor 16 and the upper conveyor 18 are not in alignment to cause material to move along a general direction of travel C-C.

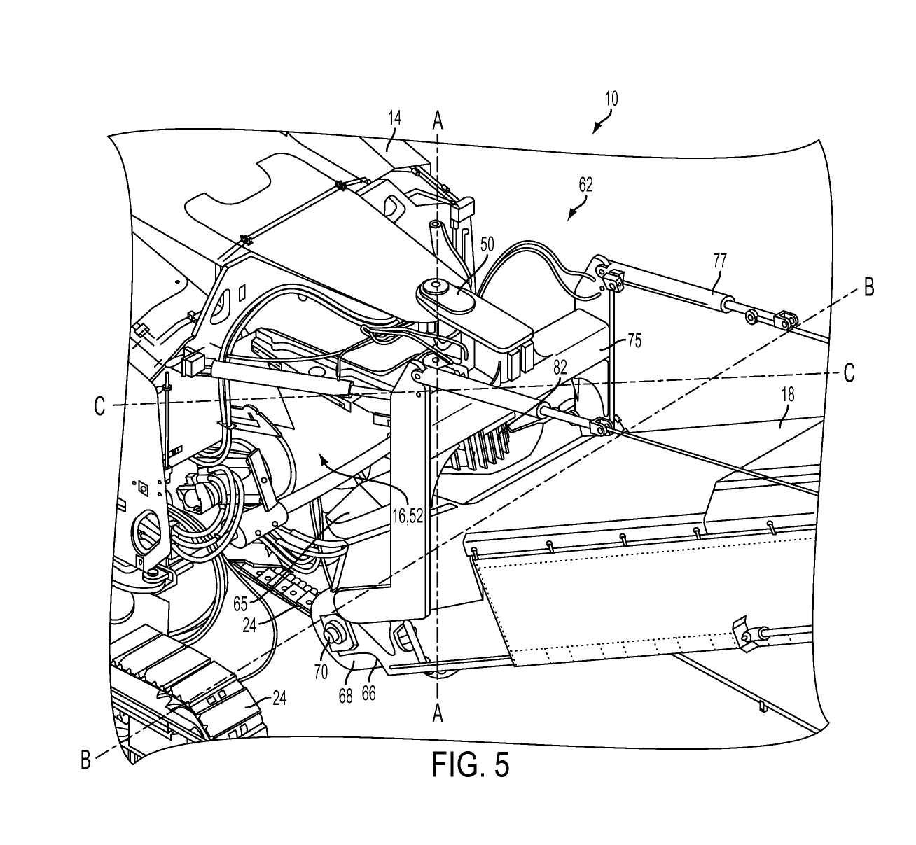

FIG. 4 is a partial side view of the lower conveyor 16 and upper conveyor 18. In the view shown in FIG. 4, the pivot axis B-B is illustrated as a pivot point 80. The upper conveyor 18 pivot from side to side along one the slew axis A-A with respect to the lower conveyor 16. This permits the upper conveyor 18 to move material either along the direction defined by the longitudinal direction of lower conveyor 16 or the material may turn when the material enters the upper conveyor 18 and move in a direction out of alignment with the longitudinal direction of lower conveyor 16 depending upon the pivotal direction of the upper conveyor 18 as that pivots about axis A-A. The upper conveyor 18 can also pivot with respect to pivot point 80 as shown in FIG. 4 or in other words about axis B-B as shown in FIGS. 3 and 5. This elevation pivoting allows the discharge and 78 of the upper conveyor 18 to be raised or lowered as needed. As illustrated in FIGS. 4 through 5, the axes A-A and B-B intersect at the upper conveyor 18 near the transition zone 62. Because these two axes A-A and B-B intersect each other they define a plane.

FIG. 5 is a partial isometric view of a transition zone 62 of part of a machine 10. The front ground engaging components or drive tracks 24 are seen. The lower conveyor 16 and associated lower conveyor belt 52 are shown. The pivotal connection 50 between the upper conveyor 18 and the machine 10 is also illustrated. The slew axis A-A extends through the pivotal connection 50 and is the axis about which the upper conveyor 18 pivots on the pivotal connection 50.

Some of the flashing 64 at the transition zone 62 has been removed in order to better illustrate the transition zone 62. The intake hopper 65 is illustrated in FIG. 5. A material hard stop 82 is mounted to the machine frame 14. In many embodiments in accordance with this disclosure, the material hard stop 82 is contained within the flashing 64 and is therefore not shown in FIGS. 3 and 4 due to concealment by the flashing 64.

The material hard stop 82 is designed to work with the mounting mechanism and working speed range of the lower conveyor belt 52, to maintain a transition intake point aligned with axis A on the upper conveyor. When the lower conveyor 16 is being run at a relatively low speed, the material coming off the lower conveyor 16 may have unimpeded travel into the intake hopper 65. The alignment of the material transition intake to the intersection of axis A-A and axis B-B in the working elevation of the secondary conveyor reduces material spillage and improves conveyor belt tracking The hard stop 82 reduces the momentum of the material along axis C-C. The primary material momentum is transferred to the upper conveyor 18 in a vertical direction.

As mentioned above, the upper conveyor 18 also pivots about the elevation axis B-B in order to raise and lower the discharge and 78 (best seen in FIG. 3) to a desired height. The desired height may be controlled by the height of a wall associated with a dump truck into which the upper conveyor 18 is depositing material. It should be appreciated that the elevation axis B-B is not necessarily the axis of the upper head pulley axle 70. In some embodiments the axis associated with the upper head pulley axles 70 and the elevation axis B-B may be the same however, in other embodiments as shown in FIGS. 3 through 5, the elevation axis B-B is not the same axis as the axis associated with the axle 70 of the upper head pulley 68.

Axis C-C illustrates a general direction of travel of material moving along the lower conveyor 16 and the upper conveyor 18. In some embodiments in accordance with the disclosure, the lower conveyor 16 is aligned with the upper conveyor 18 so that material moving along the lower conveyor 16 across the transition zone 62 and along the upper conveyor 18 moves along a substantially similar general direction of travel. In some embodiments, the material hard stop 82 is also aligned along the axis C-C. In other embodiments in accordance with the disclosure, the upper conveyor 18 is pivoted along the pivotal connection 50 about the axis A-A so that the upper conveyor 18 is not aligned with the lower conveyor 16 to cause material moving along the lower conveyor 16 across the transition zone 62 and along the upper conveyor 18 episodes potentially same direction of travel.

### INDUSTRIAL APPLICABILITY

Conveyors are often used to move material in a variety of settings. One example setting, but by no means, is a limiting example, is the use of a conveyor to move asphalt or other roadbed material from a cold planer machine to another vehicle. The second vehicle is often used to haul away the material moved by the conveyor. Due to the variety of settings and equipment that may be used in a milling operation, it may be desirable to provide a wide range of locations for the output of the material carried by the conveyor. One way to provide a multiple of locations for the output of the material is to provide a system of multiple conveyors. When multiple conveyors are used, they may be able to move by pivoting with respect to each other in order to adjust the final output of material. For example, by pivoting with respect to a slew axis (in other words, left or right with respect to a first conveyor), the output of the material may be moved to the left or to the right. By allowing the second conveyor to also pivot with respect to an elevation axis, the output of material can be raised or lowered as desired.

One of the problems associated with pivoting conveyors with respect to each other is at the transitional zone between the two conveyors provides an opportunity for material to be spilled or lost between the conveyors at the transition zone between the conveyors. When a conveyors run at a constant speed the location of the material being output from the conveyor may be predicted. In such a case, an operator may desire to place the input of a second conveyor at a location where it is predicted the output of the first conveyor will be in order to reduce the likelihood of material being spilled or lost during the transition of one conveyor to the other. However, the problem of material being lost or spilled between the conveyors is exacerbated when the speed of the two conveyors is adjusted. As the speed of a conveyor changes the location of the material being discharged can also change. For example, a conveyor run at a faster speed will “throw” material farther than the same conveyor moving the same material at lower speed. As a result, the area of where the material may end up when it comes off the conveyor is enlarged.

When the area of where the material may end up is enlarged, is more difficult to determine where the best place to put the input of the second conveyor. Further, the larger this area, the more flashing and guiding material is required to guide the material to the input of a second conveyor. Therefore it is desirable to consider ways to shrink or reduce the area of where material may end up when it is coming off a conveyor.

Another factor that can result in enlarging the transition area and therefore requiring more flashing in guiding material is the more axes the second conveyor pivots about potentially can enlarge the area where the input to the second conveyor may move. For example, if the input end of the second conveyor is in a desired location with respect to the output of the first conveyor, but the output end of the second conveyor needs to be adjusted, pivoting the second conveyor to a position where the output and is at a desired location may result in moving the input end of the second conveyor out of the desired position. This situation can result in enlarging the transition area between the two conveyors. Additional factors such as changing the working depth of the cutting drum and other movement of the first conveyor can also result in enlarging the transition area between conveyors.

An additional problem is that if the second conveyor is aligned at a significantly different angle with respect to the first conveyor, material from the first conveyor will enter the second conveyer moving in a different direction then the first conveyor. This may impart a force on the belt of the first conveyer that may tend to cause the belt of the first conveyer to move off its pulleys or come off track.

In some embodiments, these concerns are addressed by configuring and aligning the second conveyor so that the slew axis and the elevation axis about which the second conveyor pivots intersect each other and define a plane. In some embodiments, the slew axis and the elevation axis intersect proximal to an input and of the second conveyor. In some embodiments, configuring the conveyor system so that the slew axis and the elevation axis intersect and define a plane resulting in limiting the amount of travel the input end of the second conveyor does thereby reducing the size of the transitional area.

In some embodiments, the likelihood of spilling or losing material at the transitional area is reduced by aligning the first conveyor with the second conveyor to result in the material being moved along a direction of travel, and to both conveyors. Furthermore, in some embodiments, aligning the material hard stop with the common direction of travel can aid in reducing the likelihood of material being spilled or lost at the transitional area or the material entering the second conveyor to impart a force on the belt of the second conveyer to cause the belt of the second conveyer to come off of its pulleys.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A machine, comprising:
a first conveyor; and
a second conveyor that is pivotable, with respect to the first conveyor, about two different axes that intersect and define a plane.

2. The machine of claim 1, wherein one axis is a slew axis.

3. The machine of claim 1, wherein one axis is an elevation axis.

4. The machine of claim 1, wherein one axis is a slew axis and the other axis is an elevation axis.

5. The machine of claim 4, wherein the plane is perpendicular to a direction of travel of the machine.

6. The machine of claim 4, wherein the first conveyor deposits material onto the second conveyor at different speeds.

7. The machine of claim 6, further comprising a material hardstop, located proximate to the plane, to guide material deposited from the first conveyor onto the second conveyor.

8. The machine of claim 7, wherein the first conveyor, the second conveyor and the material hardstop are configured such that a discharge end of the first conveyor is located above an intake end of the second conveyor, and material deposited from the first conveyor strikes the material hardstop and falls onto the intake end of the second conveyor.

9. The machine of claim 6, further comprising flashing, located proximate to the plane, to guide material deposited from the first conveyor onto the second conveyor.

10. The machine of claim 9, wherein the first conveyor, the second conveyor and the flashing are configured such that a discharge end of the first conveyor is located above an intake end of the second conveyor, and material deposited from the first conveyor falls through an intake hopper onto the intake end of the second conveyor.

11. The machine of claim 10, further comprising a material hardstop to guide material deposited from the first conveyor onto the second conveyor.

12. The machine of claim 6, wherein the material is asphalt.

13. The machine of claim 6, further comprising a material hardstop, wherein the first conveyor, the second conveyor and the material hardstop are selectively aligned to move material along a single direction of travel.

14. The machine of claim 1, wherein the plane intersects the first conveyor but not the second conveyor.

15. A machine capable of performing a method of operating a set of conveyors, the method comprising pivoting a second conveyor with respect to a first conveyor about two different axes that intersect and define a plane.

16. The machine of claim 15, wherein one of the axes is a slew axis for the second conveyor and the other axis is an elevation axis for the second conveyor.

17. The machine of claim 15, wherein the method further comprises guiding material from the first conveyor to the second conveyor using a hopper located proximate to the plane.

18. The machine of claim 15, wherein the method further comprises guiding material from the first conveyor to the second conveyor using a material hardstop located proximate to the plane.

19. The machine of claim 18, wherein the method further comprises: adjusting the speed of the first conveyor to cause material exiting the first conveyer to hit the material hardstop and drop onto the second conveyor.

20. A machine, comprising:
a first means for conveying; and
a second means for conveying, pivotable about two different axes with respect to the first means for conveying, the two pivot axes intersecting and defining a plane.
